(19) United States
(12) Patent Application Publication
(10) Pub. No.: US 2008/0153697 A1
(43) Pub. Date: Jun. 26, 2008

(54) MIXTURES OF AMMONIA AND IONIC LIQUIDS

(75) Inventors: MARK BRANDON SHIFLETT, NEW CASTLE, DE (US); AKIMICHI YOKOZEKI, WILMINGTON, DE (US)

Correspondence Address: E I DU PONT DE NEMOURS AND COMPANY;LEGAL PATENT RECORDS CENTER, BARLEY MILL PLAZA 25/1122B, 4417 LANCASTER PIKE, WILMINGTON, DE, 19805, US

(73) Assignee: E. I. DUPONT DE NEMOURS AND COMPANY, WILMINGTON, DE (US)

(21) Appl. No.: 11/615,394

(22) Filed: Dec. 22, 2006

(51) Int. Cl. B01J 23/02

(52) U.S. Cl. 502/439

(57) ABSTRACT

Mixtures of ammonia and ionic liquids are provided that are suitable for use as absorption cooling fluids in absorption cycles, and ammonia storage.

### TECHNICAL FIELD

The present invention relates to mixtures of ammonia and ionic liquids for use as absorption cooling fluids and ammonia storage.

### BACKGROUND

The absorption refrigeration cycle is more than a 100 year old technique. Although the vapor compression cycle took over most of air-conditioning and refrigerating applications, the well-known refrigerant-absorber systems (H₂O/LiBr and NH₃/H₂O) are still being used for certain applications, particularly in the field of industrial applications or large-scale water chiller systems. Recently, more attention has been directed toward recovery of waste heat using the NH₃/H₂O system (Erickson D C, et al., “Heat-activated dual-function absorption cycle”, ASHRAE Trans. 2004, 110). Inherent drawbacks to using LiBr and NH₃ as refrigerants include the corrosiveness of LiBr and the toxicity and flammability of NH₃. In the late 1950s, some pioneering works proposed new refrigerant-absorbent pairs for the absorption cycle, using fluoroalkane refrigerants with organic absorbents (Eiseman B J, “A comparison fluoroalkane absorption refrigerants”, ASHRAE J. 1959, 1, 45; Mastrangelo S V R. “Solubility of some chlorofluorohydrocarbons in tetraethylene glycol ether”, ASHRAE J. 1959, 1, 64). Such studies continue actively even at the present time, especially among academic institutions. One drawback to using fluorinated hydrocarbons as refrigerants is the potentially adverse environmental impacts that may result from their use. Needed are new refrigerant-absorber systems.

Room-temperature ionic liquids (RTILs) are a new class of solvents and molten salts with a melting point of less than about 100° C. Because of the negligible vapor pressure, they are often called (environmentally-friendly) “green solvents”, compared with ordinary volatile organic compounds (VOCs). For the past several years, worldwide research on thermodynamic and transport properties of pure RTILs and their mixtures with various chemicals have been conducted. As a new type of solvent with immeasurable vapor pressure, room-temperature ionic liquids are being considered as absorbers with various refrigerants. For instance, Shiflett et al, US 2006/0197053 A1 disclose the use of ionic liquids as absorbents with fluorinated hydrocarbons as the refrigerant in absorption cycles. Although several other refrigerants are mentioned, including the possibility of ammonia, no example or data enabling the possibility were disclosed. Knowledge of solvent phase behaviors is highly important to determine the attractiveness of using ionic liquids in these applications as well as in new applications such as absorption cooling or heating.

Another need is a medium to store and transport volatile materials. Ammonia, for instance, is typically stored in high-pressure cylinders; or in water, as ammonium hydroxide. However, in applications where water, a medium with a significant vapor pressure at room temperature, can not be tolerated, ammonium hydroxide is not a suitable medium for storing ammonia. Conventional adsorbents, such as surface-modified active carbons and ion-exchanged zeolites, have been used for storage of ammonia. However, the ammonia storage capacities are not very high, for instance, for Cu form of Y-zeolite the storage capacity is about 5 millimol of ammonia per gram (Ind. Eng. Chem. Res. 2004, 43, 7484-7491).

Alkaline earth halides and their hydrated forms MgClOH, CaCl₂, CaBr₂, and SrBr₂ have been found to have higher capacities on the order of 25 to 40 millimol per gram (i.e. MgClOH is 26 millmol per gram). One issue with the alkaline earth halides is the adsorption requires heat to completely remove the ammonia from the surface in order to regenerate the solid. For instance, MgCl₂—CaCl₂ at 298 K adsorbs about 46 millimol of ammonia per gram of solid at 80 kPa; and further increase in pressure results in no further increase in ammonia adsorbed. Release of the pressure and evacuation of the adsorbent, followed by a second adsorption measurement shows far less ammonia can be adsorbed. For example a second adsorption measurement resulted in 14 millimol of ammonia per gram of solid at the same temperature (298 K) and pressure (80 kPa). This indicates that the absorption process is irreversible even after 1 hour of evacuation to remove all the ammonia from the first adsorption experiment. Needed are mediums that can reversibly store significant quantities of ammonia and also have very low or no vapor pressure themselves.

### SUMMARY

One aspect of the invention is a composition comprising ammonia and at least one ionic liquid wherein the composition comprises about 1 to about 99 mole % of ammonia over a temperature range from about −40 to about 130° C. at a pressure from about 1 to about 110 bar.

Another aspect of the invention is an absorption cycle comprising a composition of the invention useful for heating or cooling.

Another aspect of the invention is a process for storing ammonia comprising absorbing ammonia in an ionic liquid to provide a composition comprising about 1 to about 99 mole % of ammonia over a temperature range from about −40 to about 130° C. at a pressure from about 1 to about 110 bar.

### BRIEF DESCRIPTION OF DRAWINGS

FIG. 1 illustrates a schematic diagram of a simple absorption refrigeration cycle.

FIG. 2 illustrates a schematic diagram of a sample holder used in preparing compositions of the invention.

FIG. 3 illustrates PTx phase equilibria of NH₃/[emim][Tf₂N] mixtures.

### DETAILED DESCRIPTION

All patents and patent applications cited herein are hereby incorporated by reference. Herein all trademarks are designated with capital letters.

In this disclosure, a number of terms are used for which the following definitions are provided.

An “alkane” is a saturated hydrocarbon having the general formula CₙH₂ₙ₊₂, and may be a straight-chain, branched or cyclic.

An “alkene” is an unsaturated hydrocarbon that contains one or more carbon-carbon double bonds, and may be a straight-chain, branched or cyclic. An alkene requires a minimum of two carbons. A cyclic compound requires a minimum of three carbons.

An “aromatic” is benzene and compounds that resemble benzene in chemical behavior.

A “fluorinated ionic liquid” is an ionic liquid having at least one fluorine on either the cation or the anion. A “fluorinated cation” or “fluorinated anion” is a cation or anion, respectively, comprising at least one fluorine.

A “halogen” is bromine, iodine, chlorine or fluorine.

A “heteroaryl” group is an alkyl group having a heteroatom.

A “heteroatom” is an atom other than carbon or hydrogen in the structure of an alkanyl, alkenyl, cyclic or aromatic compound.

An “ionic liquid” is an organic salt that is fluid at about 100° C. or below, as more particularly described in Science (2003) 302:792-793.

“Optionally substituted with at least one member selected from the group consisting of”, when referring to an alkane, alkene, alkoxy, fluoroalkoxy, perfluoroalkoxy, fluoroalkyl, perfluoroalkyl, aryl or heteroaryl, means that one or more hydrogens on the carbon chain may be independently substituted with one or more of one or more members of the group. For example, substituted C₂H₅ may, without limitation, be CF₂CF₃, CH₂CH₂OH or CF₂CF₂I.

Ionic liquids can be synthesized, or obtained commercially from several companies such as Merck KGaA (Darmstadt, Germany) or BASF (Mount Olive, N.J.). The synthesis of several ionic liquids useful in the compositions of the invention is disclosed in the Shiflett, et al, US 2006/0197053 A1.

In one embodiment of the invention, the ionic liquid has a cation, herein defined as Group A Cations, selected from the group consisting of:

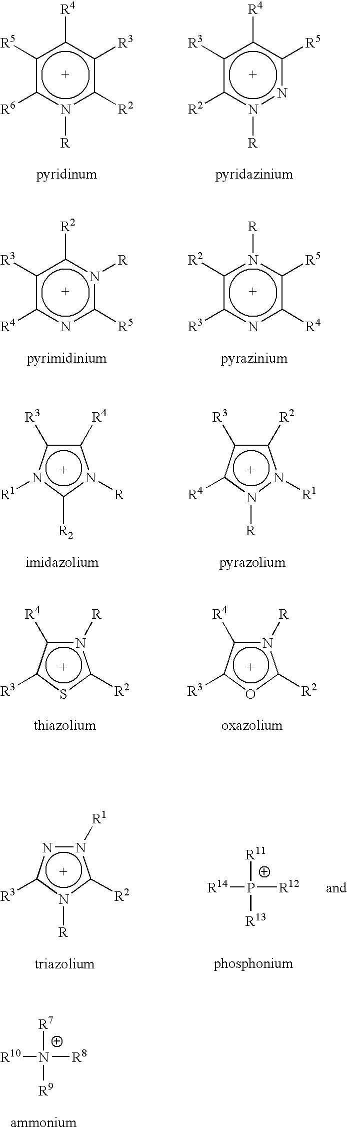

wherein R, R¹, R⁷, R⁸, R⁹, and R¹⁰ are independently selected from the group consisting of:
(i) hydrogen
(ii) —CH₃, —C₂H₅, or C₃ to C₂₅ straight-chain, branched or cyclic alkane or alkene, optionally substituted with at least one member selected from the group consisting of Cl, Br, F, I, OH, NH₂ and SH;
(iii) —CH₃, —C₂H₅, or C₃ to C₂₅ straight-chain, branched or cyclic alkane or alkene comprising one to three heteroatoms selected from the group consisting of O, N and S, and optionally substituted with at least one member selected from the group consisting of Cl, Br, F, I, OH, NH₂ and SH;
(iv) C₆ to C₂₀ unsubstituted aryl, or C₃ to C₂₅ unsubstituted heteroaryl having one to three heteroatoms independently selected from the group consisting of O, N and S; and
(v) C₆ to C₂₅ substituted aryl, or C₃ to C₂₅ substituted heteroaryl having one to three heteroatoms independently selected from the group consisting of O, N and S; and wherein said substituted aryl or substituted heteroaryl has one to three substituents independently selected from the group consisting of:
   (1) —CH₃, —C₂H₅, or C₃ to C₂₅ straight-chain, branched or cyclic alkane or alkene, optionally substituted with at least one member selected from the group consisting of Cl, Br, F I, OH, NH₂ and SH,
   (2) OH,
   (3) NH₂, and
   (4) SH;

### R², R³, R⁴, R⁵, and R⁶ are independently selected from R and a halogen;

### R¹¹, R¹², R¹³, and R¹⁴ are independently selected from R with the proviso that R¹¹, R¹², R¹³, and R¹⁴ are not hydrogen; and

wherein, optionally, at least two of R, R¹, R², R³, R⁴, R⁵, R⁶, R⁷, R⁸, R⁹, R¹⁰, R¹¹, R¹², R¹³, and R¹⁴ can together form a cyclic or bicyclic alkanyl or alkenyl group;
and an anion, herein defined as Group A Anions, selected from the group consisting of [CH₃CO₂]⁻, [HSO₄]⁻, [CH₃OSO₃]⁻, [C₂H₅OSO₃]⁻, [AlCl₄]⁻, [CO₃]²⁻, [HCO₃]⁻, [NO₂]⁻, [NO₃]⁻, [SO₄]²⁻, [PO₄]³⁻, [HPO₄]²⁻, [H₂PO₄]⁻, [HSO₃]⁻, [CuCl₂]⁻, Cl⁻, Br⁻, I⁻, SCN⁻, and a fluorinated anion.

In another embodiment, ionic liquids useful for the invention comprise fluorinated cations wherein at least one member selected from R, R¹, R², R³, R⁴, R⁵, R⁶, R⁷, R⁸, R⁹, R¹⁰, R¹¹, R¹², R¹³ and R¹⁴ comprises one or more fluorines. Included in these materials are fluorinated cations wherein one or more R², R³, R⁴, R⁵, and R⁶, may be fluorine; and wherein one or more R, R¹, R², R³, R⁴, R⁵, R⁶, R⁷, R⁸, R⁹, R¹⁰, R¹¹, R¹², R¹³ d R¹⁴ may be an alkyl, alkenyl or an aromatic group containing one or more fluorinated carbon atoms; including perfluorinated alkyl, alkenyl and aromatic groups.

Preferred fluorinated anions for the compositions of the invention, defined here as Group B Anions, are selected from the group consisting of: [BF₄]⁻, [BF₃CF₃]⁻, [BF₃C₂F₅]⁻, [PF₆]⁻, [PF₃(C₂F₅)₃]⁻, [SbF₆]⁻, [CF₃SO₃]⁻, [HCF₂CF₂SO₃]⁻, [CF₃HFCCF₂SO₃]⁻, [HCClFCF₂SO₃]⁻, [(CF₃SO₂)₂N]⁻, [(CF₃CF₂SO₂)₂N]⁻, [(CF₃SO₂)₃C]⁻, [CF₃CO₂]⁻, [CF₃OCFHCF₂SO₃]⁻, [CF₃CF₂OCFHCF₂SO₃]⁻, [CF₃CFHOCF₂CF₂SO₃]⁻, [CF₂HCF₂OCF₂CF₂SO₃]⁻, [CF₂ICF₂OCF₂CF₂SO₃]⁻, [CF₃CF₂OCF₂CF₂SO₃]⁻, [(CF₂HCF₂SO₂)₂N]⁻, [(CF₃CFHCF₂SO₂)₂N]⁻; and F⁻.

In another embodiment, ionic liquids useful in the invention comprise a Group A Cation as defined above; and a Group B Anion as defined above.

In another embodiment, ionic liquids useful in the invention comprise Group A Cation as defined above, wherein at least one member selected from R, R¹, R², R³, R⁴, R⁵, R⁶, R⁷, R⁸, R⁹, R¹⁰, R¹¹, R¹², R¹³ and R¹⁴ comprises one or more fluorines; and an anion selected from Group A Anions, as defined above. In a preferred embodiment the ionic liquids useful in the invention consists essentially of Group A Cation as defined above, wherein at least one member selected from R, R¹, R², R³, R⁴, R⁵, R⁶, R⁷, R⁸, R⁹, R¹⁰, R¹¹, R¹², R¹³ and R¹⁴ comprises one or more fluorines; and an anion selected from Group A Anions, as defined above.

In another embodiment, ionic liquids useful in the invention comprise Group A Cation as defined above, wherein at least one member selected from R, R¹, R², R³, R⁴, R⁵, R⁶, R⁷, R⁸, R⁹, R¹⁰, R¹¹, R¹², R¹³ and R¹⁴ comprises one or more fluorines; and an anion comprises a Group B Anion, as defined above.

In another embodiment, preferred ionic liquids useful for the invention comprise an imidazolium as the cation, and an anion selected from the group consisting of Group B Anions, as defined above, and [CH₃OSO₃]⁻. In a preferred embodiment, the ionic liquids useful for the invention consist essentially of an imidazolium as the cation, and an anion selected from the group consisting of Group B Anions, as defined above, and [CH₃OSO₃]⁻.

In another embodiment, preferred ionic liquids useful for the invention comprise 1-butyl-3-methylimidazolium as the cation, and an anion selected from the group consisting of Group B Anions, as defined above, and [CH₃OSO₃]⁻.

In another embodiment, preferred ionic liquids useful for the invention comprise 1-ethyl-3-methylimidazolium as the cation, and an anion selected from the group consisting of Group B Anions, as defined above, and [CH₃OSO₃]⁻.

In another embodiment, preferred ionic liquids useful for the invention comprise 1-ethyl-3-methylimidazolium as the cation, and [(CF₃CF₂SO₂)₂N]⁻, [PF₆]⁻, or [HCF₂CF₂SO₃]⁻ as the anion.

In another embodiment, preferred ionic liquids useful for the invention comprise 1,3-dimethylimidazolium as the cation, and an anion selected from the group consisting of Group B Anions, as defined above, and [CH₃OSO₃]⁻.

In another embodiment, preferred ionic liquids useful in the invention comprise a Group A Cation as defined above; and the anion is [CH₃CO₂]⁻. More preferred ionic liquids within this group are those wherein the cation is an ammonium cation. In a preferred embodiment, ionic liquids useful in the invention consist essentially of an ammonium cation; and the anion is [CH₃CO₂]⁻. An especially preferred ionic liquid is wherein the cation is N,N-dimethylammonium ethanol.

Mixtures of ionic liquids may also be useful for mixing with ammonia for use in absorption cooling cycles, for storage of ammonia.

A useful method for characterization of the ionic liquids useful in the invention is the determination of viscosity using a capillary viscometer (Cannon-Manning semi-micro viscometer) over a temperature range (283.15 to 373.15 K) as disclosed in “Standard Test Method for Kinematic Viscosity of Transparent and Opaque Liquids and the Calculation of Dynamic Viscosity”, ASTM method D445-88. Preferably the ionic liquid useful in the invention has a viscosity, as measured by ASTM method D445-88 method, at 25° C., of less than 100 centipoise (cp). The lower the viscosity of the ionic liquid, the lower the pumping power required to move a composition through an absorption cycle. Lower pumping power increases the overall efficiency of an absorption cycle. The calculated coefficient of performance (COP), as described in the examples, does not factor-in pumping power requirements. Table A lists the viscosity of several ionic fluids useful in the invention.

TABLE A
Viscosity of ionic fluids at 25° C. (cp)

| Name | cp |
|---|---|
| 1-butyl-3-methylimidazolium hexfluorophosphate | 351 |
| 1-ethyl-3-methylimidazolium bis(pentafluoroethylsulfonyl)imide | 85 |
| 3-methyl-1-propylimidazolium bis(trifluoromethylsulfonyl)imide | 60 |
| 1-hexyl-3-methylimidazolium | 92 |
| tris(pentafluoroethyl)trifluorophosphate | |
| 1,2-dimethyl-3-propylimidazolium | 636 |
| tris(trifluoromethylsulfonyl)methide | |
| 1-ethyl-3-methylimidazolium bis(trifluoromethylsulfonyl)imide | 31 |
| 1-ethyl-3-methylimidazolium acetate | 93 |
| 1-butyl-3-methylimidazolium | 267 |
| 1,1,2,3,3,3-hexafluoropropanesulfonate | |
| 1-butyl-3-methylimidazolium 1,1,2-trifluoro-2- | 311 |
| (perfluoroethoxy)ethanesulfonate | |
| 1-butyl-3-methylimidazolium 1,1,2-trifluoro-2- | 217 |
| (trifluoromethoxy)ethanesulfonate | |
| tetradecyl(trihexyl)phosphonium 1,1,2,-trifluoro-2- | 448 |
| (perfluoroethoxy)ethanesulfonate | |
| tributyl(tetradecyl)phosphonium | 774 |
| 1,1,2,3,3,3-hexafluoropropanesulfonate | |
| 1-butyl-3-methylimidazolium tetrafluoroborate | 122 |
| 1-butyl-3-methylpyrrolidinium | 80 |
| bis(trifluoromethylsulfonyl)imide | |
| 1-butyl-3-methylimidazolium | 47 |
| bis(trifluoromethylsulfonyl)imide | |
| 1-butyl-3-methyljimidazolium | 146 |
| 1,1,2,2-tetrafluoroethanesulfonate | |
| 1-butyl-3-methyljimidazolium dicyanamide | <100 |
| 1-ethyl-3-methylimidazolium tetrafluoroborate | <100 |
| 1-butyl-1-methylpyrrolidinium dicyanamide | <100 |
| 1-ethyl-3-methylimidazolium thiocyanate | <100 |
| 1-butyl-3-methylimidazolium tricyanomethide | <100 |
| N-butyl-3-methylpyridinium dicyanamide | <100 |

The compositions comprising ammonia and ionic liquid can be prepared adding a weighed amount of ionic fluid to a sealable vessel, followed by applying a vacuum, with heating if so desired, to remove any residual water. The vessel can be tared and then ammonia gas added. The vessel is sealed and the mixture equilibrated with occasional agitation to provide a solution of ammonia in the ionic liquid.

The ammonia solutions can be used as a storage medium for anhydrous ammonia. Heating the ammonia-ionic liquid mixture is sufficient to drive the ammonia into the vapor phase, leaving behind the ionic liquid that has substantially no measurable vapor pressure. The ammonia-ionic liquid composition can be heated to about 200° C., or about 150° C., or preferably about 100° C., or less, to liberate the ammonia from solution.

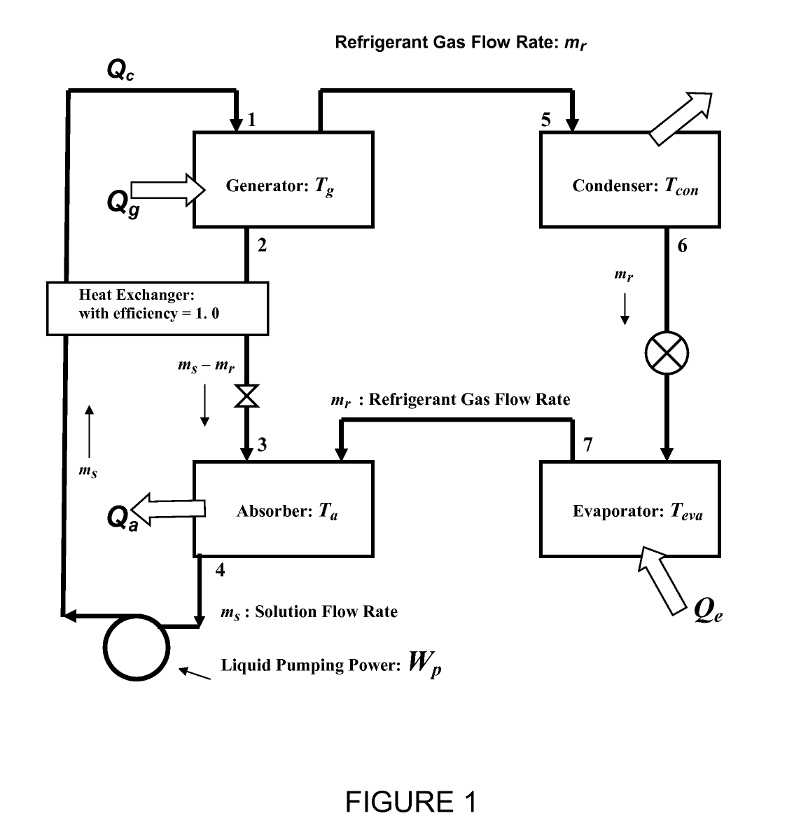

The compositions are also useful in absorption cycles for heating or cooling. An embodiment of the invention is an absorption cycle comprising a composition comprising ammonia and at least one ionic liquid wherein the composition comprises about 1 to about 99 mole % of ammonia over a temperature range from about −40 to about 130° C. at a pressure from about 1 to about 110 bar. A schematic diagram for a simple absorption cycle is shown in FIG. 1. The system is composed of condenser and evaporator units with an expansion valve similar to an ordinary vapor compression cycle, but an absorber-generator solution circuit replaces the compressor. The circuit maybe composed of an absorber, a generator, a heat exchanger, a pressure control device and a pump for circulating the solution.

One embodiment is an absorption cycle wherein the ionic liquid comprises a Group A Cation as defined above; and a Group A Anions as defined above.

In another embodiment the absorption cycle comprises an absorber side having an exit, and a generator side having an exit, wherein the absorber side has a concentration of ionic liquid at the exit of greater than about 70% by weight of said composition; and the generator side has a concentration of ionic liquid at the exit of greater than about 80% by weight of said composition. In this embodiment a preferred ionic liquid comprises a N,N-dimethylammonium ethanol cation.

In another embodiment, in the absorption cycle, the absorber side has a concentration of ionic liquid at the exit of greater than about 80% by weight of said composition; and the generator side has a concentration of ionic liquid at the exit of greater than about 90% by weight of said composition. In this embodiment a preferred ionic liquid comprises an imidazolium cation.

The starting volumes of the ionic and liquid and ammonia will depend on the specific system components being used in the absorption cycle.

In order to understand the absorption cycle and to evaluate the cycle performance, thermodynamic property charts such as temperature-pressure-concentration (TPX) and enthalpy-temperature (HT) diagrams are required. These charts correspond to the familiar PH (pressure-enthalpy) or TS (temperature-entropy) diagram in the vapor compression cycle analysis. However, the use of these charts may not be as straightforward as vapor compression with a compressor, where the compression process is theoretically a single isentropic path, while the absorption cycle employs the so-called generator-absorber solution circuit, and several thermodynamic processes are involved.

The PH or TS diagram in the vapor compression cycle is constructed using equations of state (EOS), and the cycle performance and all thermodynamic properties can be calculated according to the discussion and equations described in Shiflett et al, US 2006/0197053 A1. The results of these calculations for several compositions of the invention are listed in Table 9 (Example 9). The well-known refrigerant-absorbent pair, NH₃/H₂O also has been calculated and is for comparison. In the case of NH₃/H₂O, the absorbent H₂O has a non-negligible vapor pressure at the generator exit, and in practical applications a rectifier (distillation) unit is required in order to separate the refrigerant from absorbent water. The effect of vapor pressure and extra power requirement due to the rectifier have been ignored; thus, the calculated COP is over-estimated for the present performance comparison. As the COP values indicate, several compositions have properties similar to the convention ammonia-water absorption cycle.

Preferred compositions for absorption cycles and storage processes have about 5 mol % to about 95 mol % ammonia; about 10 mol % to about 95 mol % ammonia; and about 25 mol % to about 85 mol % ammonia.

### EXAMPLES

### General Methods and Materials

High purity, anhydrous ammonia (purity≧99.999%, semiconductor grade, CAS no. 2664-41-7) was obtained from MG Industries (Philadelphia, Pa.). The following ionic liquids were used in the examples: 1-butyl-3-methylimidazolium hexafluorophosphate ([bmim][PF₆], assay≧96%, CAS no. 174501-64-5), 1-hexyl-3-methylimidazolium chloride ([hmim][CI], assay≧97%, CAS no. 171058-17-6), 1-ethyl-3-methylimidazolium bis(trifluoromethylsulfonyl)imide ([emim][Tf₂N], assay≧97%, CAS no. 174899-82-2), 1-butyl-3-methylimidazolium tetrafluoroborate ([bmim][BF₄], assay≧97%, CAS no. 174501-65-6), 1-ethyl-3-methylimidazolium acetate ([emim][CH₃COO], assay≧90%, CAS no. 143314-17-4), 1-ethyl-3-methylimidazolium ethylsulfate ([emim][EtOSO₃], assay≧95%, CAS no. 343573-75-5), and 1-ethyl-3-methylimidazolium thiocyanate ([emim][SCN], assay≧95%, CAS no. 331717-63-6). They were obtained from Fluka (Buchs, Switzerland) also distributed by Sigma-Aldrich in the United States. The N,N-dimethylethanolammonium ethanoate (also called acetate, assay≧99%) was obtained from Bioniqs (York, England).

All of the ionic liquid samples were dried and degassed, with the exception of N,N-dimethylethanolammonium ethanoate, by placing the samples in borosilicate glass tubes and applying a course vacuum with a diaphragm pump (Pfeiffer, model MVP055-3) for about 3 h. The samples were then dried at a pressure of about 4×10⁻⁷ kPa while simultaneously heating and stirring the ionic liquids at a temperature of about 348 K for 48 h.

The syntheses of non-commercially available anions (potassium 1,1,2,2-tetrafluoroethanesulfonate, potassium-1,1,2-trifluoro-2-(perfluoroethoxy)ethanesulfonate, potassium-1,1,2-trifluoro-2-(trifluoromethoxy)ethanesulfonate, and sodium 1,1,2,3,3,3-hexafluoropropanesulfonate) and ionic liquids (1-butyl-2,3-dimethylimidazolium 1,1,2,2-tetrafluoroethanesulfonate, 1-butyl-methylimidazolium 1,1,2,2-tetrafluoroethanesulfonate, 1-ethyl-3-methylimidazolium 1,1,2,2-tetrafluoroethane sulfonate, 1-ethyl-3-methylimidazolium 1,1,2,3,3,3-hexafluoropropanesulfonate, 1-hexyl-3-10 methylimidazolium 1,1,2,2-tetrafluoroethanesulfonate, 1-dodecyl-3-methylimidazolium 1,1,2,2-tetrafluoroethanesulfonate, -hexadecyl-3-methylimidazolium 1,1,2,2-tetrafluoroethanesulfonate, 1-octadecyl-3-methylimidazolium 1,1,2,2-tetrafluoroethaneulfonate, 1-propyl-3-(1,1,2,2-TFES) imidazolium 1,1,2,2-tetrafluoroethanesulfonate, 1-butyl-3-methylimidazolium 1,1,2,3,3,3-hexafluoropropanesulfonate, 1-butyl-3-methylimidazolium 1,1,2-trifluoro-2-(trifluoromethoxy)ethanesulfonate, 1-butyl-3-methylimidazolium 1,1,2-trifluoro-2-(perfluoroethoxy)ethanesulfonate, tetradecyl(tri-n-butyl)phosphonium 1,1,2,3,3,3-hexafluoropropanesulfonate, tetradecyl(tri-n-hexyl)phosphonium 1,1,2-trifluoro-2-(perfluoroethoxy)ethanesulfonate, tetradecyl(tri-n-hexyl)phosphonium 1,1,2-trifluoro-2-(trifluoromethoxy)ethanesulfonate, 1-ethyl-3-methyl imidazolium 1,1,2,2-tetrafluoro-2-(pentafluoroethoxy)sulfonate, and tetrabutylphosphonium 1,1,2-trifluoro-2-(perfluoroethoxy)ethanesulfonate) are described Shiflett, et al. US 2006/0197053 A1.

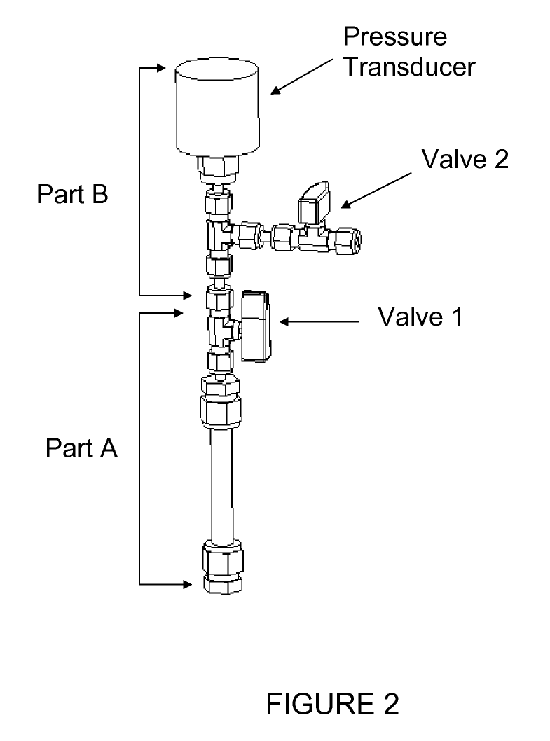

The following method was employed to determine if mixtures of ammonia and ionic liquids were soluble. Six static phase equilibrium cells were constructed as shown in FIG. 2. Each cell was made using SWAGELOK fittings, two SWAGELOK ball valves (SS-426S4), stainless steel tubing, and a pressure transducer (Dwyer Instruments, model 682-5). The internal volume of each cell was calculated by measuring the mass of methanol required to completely fill the cell. Knowing the density of methanol at the fill temperature, the volume was calculated. The internal volume of each cell (V_{T}) was in the range of about 13.4 to 15.3±0.1 cm³. The lower half (part A) of the cell as shown in FIG. 2 was used to prepare the NH₃/ionic liquid mixtures. Ionic liquid was loaded by mass (0.5 to 2 g) and weighed on an analytical balance, with a resolution of 0.1 mg, inside a nitrogen purged dry box. A syringe fitted with a stainless steel needle (Popper & Son, Inc. model 7937, 18×152.4 mm pipetting needle) which fit through the open ball valve (valve 1) was used to fill the cell with ionic liquid. The ball valve was closed and the cell was removed from the dry box. The cell was connected to a diaphragm pump to remove residual nitrogen and weighed again to obtain the initial ionic liquid mass.

The NH₃ gas was loaded by mass (0.02 to 0.8 g) from a high pressure gas cylinder. The NH₃ gas pressure was regulated to about 500 kPa with a two-stage gas regulator (Matheson Gas Products). The sample tubing between the gas regulator and cell was evacuated prior to filling with NH₃ gas. The cell was placed on an analytical balance and gas was slowly added until the desired mass of NH₃ was obtained. For samples that required more than 0.1 g of NH₃, the cell was cooled in dry ice to condense NH₃ gas inside the cell. To obtain the final mass of NH₃ added to the cell, the sample valve (valve 1) was closed and the cell was disconnected from the gas cylinder, and weighed on the analytical balance. The upper half of the cell (part B) which included the pressure transducer was connected with a Swagelok fitting to the lower half (part A). The interior volume of part B was evacuated through valve 2 using the diaphragm pump. Valve 2 was closed and capped and valve 1 was opened. The six sample cells were placed inside a tank and the temperature was controlled with an external temperature bath, either a water bath (VWR International, Model 1160S), or an oil bath (Tamson Instruments TV4000LT hot oil bath), circulating through a copper coil submerged in the tank. The temperature was initially set at about 283 K. The sample cells were vigorously shaken to assist with mixing prior to being immersed in the tank. The water or oil level in the tank was adjusted such that the entire cell was under fluid including the bottom 2 cm of the pressure transducer. The cells were rocked back and forth in the tank to enhance mixing. The pressure was recorded every hour until no change in pressure was measured. To ensure the samples were at equilibrium and properly mixed, the cells were momentarily removed from the tank and again vigorously shaken. The cells were placed back in the tank and the process was repeated until no change in pressure was measured. In all cases the cells reached equilibrium in 4 to 8 hours. The process was repeated at higher temperatures of about 298 K, 323 K and 348 K. Additional measurements at 355 K were made for [bmim][PF₆] and [bmim][BF₄] examples, and 373 K measurements were made for ([emim][EtOSO₃], [emim][SCN], and N,N-dimethylethanolammonium ethanoate.

The Dwyer pressure transducers were calibrated against a Paroscientific Model 760-6K pressure transducer (range 0 to 41.5 MPa, serial no. 62724). This instrument is a NIST certified secondary pressure standard with a traceable accuracy of 0.008% of full scale (FS). Also, due to the fact that the pressure transducers were submerged in the water or oil bath, the pressure calibration was also corrected for temperature effects. The Fluke thermometer was calibrated using a standard platinum resistance thermometer (SPRT model 5699, Hart Scientific, range 73 to 933 K) and readout (Blackstack model 1560 with SPRT module 2560). The Blackstack instrument and SPRT are also a certified secondary temperature standard with a NIST traceable accuracy to ±0.005 K. The temperature and pressure uncertainties were ±0.1 K and ±0.13% full scale (0-7 MPa). Liquid phase NH₃ mole fractions are calculated based on the prepared feed composition and the volume of the sample container, and the detailed method is described in the following subsection.

Given that a mixture of NH₃+RTIL was prepared in a container (volume V_{T}) with a mole of NH₃ (M₁) and a mole of RTIL (M₂), the following principles were used in order to find out a mole fraction (x₁) of NH₃ in the liquid phase at a given system temperature and pressure (i.e., equilibrium T and P).

The present method is based on the following liquid molar volume formula for an N-component system:

$$\overline{{V}_{L}} = \frac{1}{2} {\sum }_{i , j = 1}^{N} ( {V}_{1}^{0} + {V}_{2}^{0} ) ( 1 - {m}_{ij} ) {x}_{i} {x}_{j} , \\ {m}_{ii} = 0 and {m}_{ij} = {m}_{ji} . \qquad ( 1 )$$

This is the same form as the mixing rule for the volume parameter (b) in the common cubic EOS with the binary interaction parameter. In the case of a binary system (N=2),

$$\begin{matrix}\overline{{V}_{L}} = {V}_{1}^{0} {x}_{1} + {V}_{2}^{0} {x}_{2} - {m}_{12} ( {V}_{1}^{0} + {V}_{2}^{0} ) {x}_{1} {x}_{2} , & ( 2 ) \\ where {x}_{1} = \frac{{M}_{L 1}}{{M}_{L 1} + {M}_{L 2}} , and {x}_{2} = 1 - {x}_{1} , & ( 3 )\end{matrix}$$

### (M_{L1} is a NH₃ mole in the liquid phase).

It should be mentioned here that eqs 1 and 2 are exact when m₁₂=0 (or mᵢⱼ=0); that is when the excess volume is zero.

A physical liquid volume, V_{L}, is given by:

V_{L}=(M_{L1}+M₂) V̅_{L}. (4)

Then, a mass balance equation provides, when the gas phase is pure NH₃:

M₁=D_{g}(V_{T}−V_{L})+M_{L1}. (5)

Inserting eq 4 into eq 5 using eqs 2 and 3, and then rearranging the equation, we can obtain the following quadratic equation for M_{L1}:

AM_{L1}²+BM_{L1}+C=0, (6)

and the solution is:

$${M}_{L 1} = \frac{- B + \sqrt{{B}^{2} - 4 AC}}{2 A} \qquad ( 7 )$$

where A, B, and C are given by:

A≡1−D_{g}V₁⁰ (8)

B≡D_{g}{V_{T}−M₂ (V₁⁰+V₂⁰)(1−m₁₂)}+M₂−M₁ (9)

C≡D_{g}M₂(V_{T}−M₂V₂⁰)−M₁M₂, (10)

with the following notations,

D_{g}=NH₃ gaseous molar density (mol/cc) at the system T and P,

V₁⁰=NH₃ saturated liquid molar volume (cc/mol) at the system T,

V₂⁰=RTIL saturated liquid molar volume (cc/mol) at the system T,

m₁₂=a binary interaction parameter for the mixture volume.

D_{g} and V₁⁰ are calculated with an accurate equation of state such as that in REFPROP (NIST reference), while V₂⁰ is obtained from the liquid density and molecular weight of RTIL. The liquid density (ρ₂) has been fitted to experimental data with a linear T function.

ρ₂=a₀+a₁T (11)

Then, by setting a proper value in m₁₂, the solution of eq 7 gives x₁, from eq 3. Although this information about x₁ is sufficient for the present purpose, it is instructive to show the following relations. The liquid volume, eq 4 as well as liquid (molar) quality factor α can also be calculated:

$$α = \frac{{M}_{L 1} + {M}_{2}}{{M}_{1} + {M}_{2}} . \qquad ( 12 )$$

Also, the excess molar volume, V̅^{E}, is given by V̅^{E}=−m₁₂(V₁⁰+V₂⁰)x₁x₂ based on eq 2. When an excess molar volume is 10% of the total molar volume at a 50/50 mole % mixture, m₁₂ will be ±0.2. Then, if we use m₁₂=0, instead of m₁₂=±0.2, the maximum error in x₁ is about 0.3 mole % at the highest T and the highest x₁, and typical errors are equal to or less than 0.1 mole %. In the present study, we estimated m₁₂ to be 0.2, based on the excess molar volume measurement for NH₃ (about 47-50 mole %) and [emim][Tf₂N] mixtures at 298 K; V̅^{E}=−15±5 cm³mol⁻¹.

### Example 1

Experimental solubility (TPx) data for ammonia in [bmim][PF₆] are summarized in Table 1.

TABLE 1
NH₃ (1) + [bmim][PF₆] (2)

| T/K | P/MPa | 100x₁/mol % |
|---|---|---|
| 283.4 | 0.138 | 37.1 ± 1.4 |
| 283.4 | 0.194 | 47.1 ± 1.0 |
| 283.4 | 0.259 | 58.4 ± 0.5 |
| 283.4 | 0.517 | 86.2 ± 0.4 |
| 298.0 | 0.174 | 35.1 ± 3.0 |
| 298.0 | 0.272 | 43.5 ± 1.7 |
| 298.0 | 0.362 | 55.7 ± 1.1 |
| 298.0 | 0.609 | 74.0 ± 0.6 |
| 298.0 | 0.796 | 85.4 ± 0.4 |
| 324.6 | 0.274 | 29.2 ± 2.5 |
| 324.6 | 0.423 | 38.9 ± 1.5 |
| 324.6 | 0.583 | 49.2 ± 1.0 |
| 324.6 | 1.083 | 68.1 ± 0.6 |
| 324.6 | 1.567 | 82.8 ± 0.4 |
| 347.2 | 0.345 | 25.3 ± 2.1 |
| 347.2 | 0.546 | 33.4 ± 1.3 |
| 347.2 | 0.772 | 43.1 ± 0.9 |
| 347.2 | 1.492 | 61.7 ± 0.5 |
| 347.2 | 2.385 | 79.1 ± 0.4 |
| 355.8 | 0.371 | 23.9 ± 2.0 |
| 355.8 | 0.585 | 31.8 ± 1.3 |
| 355.8 | 0.835 | 41.1 ± 0.9 |
| 355.8 | 1.623 | 59.6 ± 0.5 |
| 355.8 | 2.700 | 77.3 ± 0.4 |
| 298.6 | 0.184 | 34.4 ± 2.9 |
| 298.6 | 0.275 | 43.4 ± 1.7 |
| 298.6 | 0.372 | 55.4 ± 1.1 |
| 298.6 | 0.635 | 73.7 ± 0.6 |
| 298.6 | 0.822 | 85.3 ± 0.4 |

### Example 2

Experimental solubility (TPx) data for ammonia in [bmim][BF₄] are summarized in Table 2.

TABLE 2
NH₃ (1) + [bmim][BF₄] (2)

| T/K | P/MPa | 100x₁/mol % |
|---|---|---|
| 282.2 | 0.091 | 20.1 ± 16.5 |
| 282.2 | 0.134 | 30.3 ± 6.8 |
| 282.2 | 0.187 | 40.4 ± 3.4 |
| 282.2 | 0.290 | 58.2 ± 1.4 |
| 282.2 | 0.396 | 70.9 ± 0.8 |
| 282.2 | 0.497 | 84.4 ± 0.4 |
| 298.4 | 0.128 | 17.3 ± 14.2 |
| 298.4 | 0.196 | 26.6 ± 6.0 |
| 298.4 | 0.272 | 36.7 ± 3.1 |
| 298.4 | 0.437 | 54.8 ± 1.3 |
| 298.4 | 0.613 | 68.3 ± 0.8 |
| 298.4 | 0.818 | 83.3 ± 0.4 |
| 323.6 | 0.196 | 12.2 ± 10.1 |
| 323.6 | 0.308 | 19.9 ± 4.5 |
| 323.6 | 0.432 | 29.2 ± 2.5 |
| 323.6 | 0.713 | 47.3 ± 1.2 |
| 323.6 | 1.049 | 62.2 ± 0.7 |
| 323.6 | 1.535 | 80.5 ± 0.4 |
| 347.5 | 0.257 | 8.0 ± 6.6 |
| 347.5 | 0.409 | 14.0 ± 3.2 |
| 347.5 | 0.582 | 21.9 ± 1.9 |
| 347.5 | 0.977 | 39.1 ± 1.0 |
| 347.5 | 1.493 | 54.2 ± 0.7 |
| 347.5 | 2.375 | 75.9 ± 0.4 |
| 355.1 | 0.275 | 6.8 ± 5.6 |
| 355.1 | 0.445 | 11.7 ± 2.7 |
| 355.1 | 0.629 | 19.5 ± 1.7 |
| 355.1 | 1.058 | 36.4 ± 1.0 |
| 355.1 | 1.626 | 51.6 ± 0.6 |
| 355.1 | 2.570 | 74.9 ± 0.4 |
| 298.6 | 0.127 | 17.4 ± 14.3 |
| 298.6 | 0.196 | 26.7 ± 6.0 |
| 298.6 | 0.271 | 36.7 ± 3.1 |
| 298.6 | 0.437 | 54.8 ± 1.3 |
| 298.6 | 0.616 | 68.3 ± 0.8 |
| 298.6 | 0.807 | 83.4 ± 0.4 |

### Example 3

Experimental solubility (TPx) data for ammonia in [emim][Tf₂N] are summarized in Table 3.

TABLE 3
NH₃ (1) + [emim][Tf₂N] (2)

| T/K | P/MPa | 100x₁/mol % |
|---|---|---|
| 283.3 | 0.114 | 22.0 ± 18.1 |
| 283.3 | 0.222 | 50.4 ± 4.3 |
| 283.3 | 0.330 | 63.4 ± 2.3 |
| 283.3 | 0.479 | 81.1 ± 1.0 |
| 283.3 | 0.606 | 93.1 ± 0.5 |
| 283.3 | 0.618 | 94.8 ± 0.4 |
| 299.4 | 0.136 | 17.1 ± 14.2 |
| 299.4 | 0.287 | 43.0 ± 3.6 |
| 299.4 | 0.434 | 56.8 ± 2.1 |
| 299.4 | 0.698 | 76.8 ± 1.0 |
| 299.4 | 0.969 | 92.1 ± 0.5 |
| 299.4 | 0.994 | 94.3 ± 0.4 |
| 323.4 | 0.171 | 8.9 ± 7.5 |
| 323.4 | 0.379 | 30.5 ± 2.6 |
| 323.4 | 0.582 | 44.4 ± 1.6 |
| 323.4 | 1.019 | 67.3 ± 0.9 |
| 323.4 | 1.711 | 88.8 ± 0.5 |
| 323.4 | 1.840 | 92.6 ± 0.4 |
| 347.6 | 0.196 | 4.5 ± 4.1 |
| 347.6 | 0.457 | 19.8 ± 1.7 |
| 347.6 | 0.709 | 32.3 ± 1.2 |
| 347.6 | 1.285 | 55.8 ± 0.8 |
| 347.6 | 2.488 | 81.8 ± 0.5 |
| 347.6 | 2.860 | 88.6 ± 0.4 |
| 298.4 | 0.145 | 13.7 ± 11.4 |
| 298.4 | 0.288 | 42.7 ± 3.6 |
| 298.4 | 0.427 | 57.3 ± 2.1 |
| 298.4 | 0.683 | 77.2 ± 1.0 |
| 298.4 | 0.940 | 92.2 ± 0.5 |
| 298.4 | 0.958 | 94.4 ± 0.4 |

### Example 4

Experimental solubility (TPx) data for ammonia in [hmim][CI] are summarized in Table 4.

TABLE 4
NH₃ (1) + [hmim][Cl] (2)

| T/K | P/MPa | 100x₁/mol % |
|---|---|---|
| 283.1 | 0.044 | 9.5 ± 8.2 |
| 283.1 | 0.094 | 25.4 ± 3.5 |
| 283.1 | 0.151 | 36.3 ± 1.9 |
| 283.1 | 0.252 | 56.2 ± 1.0 |
| 283.1 | 0.415 | 74.5 ± 0.5 |
| 283.1 | 0.511 | 83.7 ± 0.4 |
| 297.8 | 0.059 | 8.6 ± 7.3 |
| 297.8 | 0.133 | 23.1 ± 3.2 |
| 297.8 | 0.216 | 33.7 ± 1.8 |
| 297.8 | 0.377 | 53.7 ± 1.0 |
| 297.8 | 0.647 | 72.8 ± 0.5 |
| 297.8 | 0.816 | 82.8 ± 0.4 |
| 324.3 | 0.103 | 6.0 ± 5.1 |
| 324.3 | 0.198 | 19.4 ± 2.7 |
| 324.3 | 0.327 | 29.4 ± 1.6 |
| 324.3 | 0.633 | 47.9 ± 0.9 |
| 324.3 | 1.186 | 68.1 ± 0.5 |
| 324.3 | 1.600 | 79.9 ± 0.4 |
| 347.9 | 0.102 | 6.5 ± 5.5 |
| 347.9 | 0.246 | 17.2 ± 2.4 |
| 347.9 | 0.436 | 25.3 ± 1.3 |
| 347.9 | 0.883 | 41.9 ± 0.8 |
| 347.9 | 1.727 | 62.4 ± 0.5 |
| 347.9 | 2.490 | 75.6 ± 0.4 |
| 298.1 | 0.053 | 9.0 ± 7.7 |
| 298.1 | 0.111 | 24.6 ± 3.4 |
| 298.1 | 0.190 | 34.9 ± 1.8 |
| 298.1 | 0.373 | 53.6 ± 1.0 |
| 298.1 | 0.649 | 72.8 ± 0.5 |
| 298.1 | 0.819 | 82.8 ± 0.4 |

### Example 5

Experimental solubility (TPx) data for ammonia in [emim][CH₃COO] are summarized in Table 5.

TABLE 5
NH₃ (1) + [emim][CH₃COO] (2)

| T/K | P/MPa | 100x₁/mol % |
|---|---|---|
| 282.5 | 0.321 | 62.4 ± 1.2 |
| 282.5 | 0.435 | 74.9 ± 0.8 |
| 282.5 | 0.488 | 80.2 ± 0.4 |
| 282.5 | 0.525 | 83.4 ± 0.4 |
| 282.5 | 0.535 | 84.7 ± 0.4 |
| 282.5 | 0.550 | 87.7 ± 0.4 |
| 298.3 | 0.470 | 59.9 ± 2.0 |
| 298.3 | 0.667 | 73.0 ± 1.2 |
| 298.3 | 0.765 | 78.8 ± 0.8 |
| 298.3 | 0.820 | 82.5 ± 0.8 |
| 298.3 | 0.850 | 83.9 ± 0.8 |
| 298.3 | 0.898 | 87.1 ± 0.4 |
| 324.5 | 0.792 | 53.8 ± 4.0 |
| 324.5 | 1.178 | 68.3 ± 3.2 |
| 324.5 | 1.420 | 75.0 ± 2.4 |
| 324.5 | 1.568 | 79.5 ± 1.6 |
| 324.5 | 1.633 | 81.4 ± 1.6 |
| 324.5 | 1.774 | 85.2 ± 1.2 |
| 348.5 | 1.098 | 47.3 ± 6.8 |
| 348.5 | 1.710 | 62.0 ± 6.0 |
| 348.5 | 2.134 | 69.4 ± 5.2 |
| 348.5 | 2.423 | 75.1 ± 4.0 |
| 348.5 | 2.569 | 77.3 ± 3.6 |
| 348.5 | 2.891 | 81.9 ± 2.8 |
| 298.2 | 0.463 | 60.1 ± 2.0 |
| 298.2 | 0.662 | 73.1 ± 1.2 |
| 298.2 | 0.759 | 78.9 ± 0.8 |
| 298.2 | 0.818 | 82.5 ± 0.8 |
| 298.2 | 0.845 | 83.9 ± 0.8 |
| 298.2 | 0.896 | 87.1 ± 0.4 |

### Example 6

Experimental solubility (TPx) data for ammonia in [emim][EtOSO₃] are summarized in Table 6.

TABLE 6
NH₃ (1) + [emim][EtOSO₃] (2)

| T/K | P/MPa | 100x₁/mol % |
|---|---|---|
| 282.7 | 0.287 | 53.6 ± 0.9 |
| 282.7 | 0.427 | 70.7 ± 0.6 |
| 282.7 | 0.517 | 80.5 ± 0.3 |
| 282.7 | 0.544 | 83.9 ± 0.2 |
| 282.7 | 0.586 | 87.5 ± 0.1 |
| 297.6 | 0.418 | 51.8 ± 1.4 |
| 297.6 | 0.651 | 69.4 ± 0.9 |
| 297.6 | 0.802 | 79.8 ± 0.5 |
| 297.6 | 0.855 | 83.3 ± 0.4 |
| 297.6 | 0.916 | 87.1 ± 0.2 |
| 322.3 | 0.706 | 47.7 ± 2.6 |
| 322.3 | 1.166 | 66.1 ± 1.9 |
| 322.3 | 1.510 | 77.8 ± 1.2 |
| 322.3 | 1.641 | 81.8 ± 0.9 |
| 322.3 | 1.771 | 86.2 ± 0.5 |
| 347.5 | 1.051 | 42.4 ± 4.4 |
| 347.5 | 1.819 | 61.3 ± 3.8 |
| 347.5 | 2.500 | 74.4 ± 2.6 |
| 347.5 | 2.790 | 79.0 ± 2.1 |
| 347.5 | 3.091 | 84.4 ± 1.3 |
| 372.3 | 2.461 | 56.2 ± 6.2 |
| 372.3 | 3.593 | 69.7 ± 5.1 |
| 372.3 | 4.118 | 74.7 ± 4.5 |
| 372.3 | 4.777 | 81.2 ± 3.2 |
| 298.1 | 0.421 | 51.8 ± 1.4 |
| 298.1 | 0.653 | 69.4 ± 0.9 |
| 298.1 | 0.812 | 79.8 ± 0.5 |
| 298.1 | 0.869 | 83.3 ± 0.4 |
| 298.1 | 0.933 | 87.1 ± 0.2 |

### Example 7

Experimental solubility (TPx) data for ammonia in [emim][SCN] are summarized in Table 7.

TABLE 7
NH₃ (1) + [emim][SCN] (2)

| T/K | P/MPa | 100x₁/mol % |
|---|---|---|
| 283.2 | 0.244 | 45.1 ± 0.7 |
| 283.2 | 0.364 | 65.2 ± 0.5 |
| 283.2 | 0.447 | 73.1 ± 0.4 |
| 283.2 | 0.502 | 78.6 ± 0.2 |
| 283.2 | 0.547 | 81.9 ± 0.2 |
| 283.2 | 0.590 | 87.6 ± 0.1 |
| 298.1 | 0.307 | 44.4 ± 0.9 |
| 298.1 | 0.536 | 64.2 ± 0.7 |
| 298.1 | 0.672 | 72.3 ± 0.5 |
| 298.1 | 0.747 | 78.1 ± 0.4 |
| 298.1 | 0.815 | 81.5 ± 0.3 |
| 298.1 | 0.911 | 87.4 ± 0.1 |
| 322.6 | 0.535 | 41.6 ± 1.6 |
| 322.6 | 0.961 | 61.8 ± 1.4 |
| 322.6 | 1.241 | 70.4 ± 1.1 |
| 322.6 | 1.420 | 76.6 ± 0.8 |
| 322.6 | 1.562 | 80.4 ± 0.6 |
| 322.6 | 1.777 | 86.9 ± 0.3 |
| 348.0 | 0.840 | 37.8 ± 2.7 |
| 348.0 | 1.553 | 58.1 ± 2.6 |
| 348.0 | 2.045 | 67.3 ± 2.2 |
| 348.0 | 2.419 | 74.1 ± 1.7 |
| 348.0 | 2.711 | 78.4 ± 1.4 |
| 348.0 | 3.174 | 85.8 ± 0.8 |
| 372.8 | 1.149 | 34.0 ± 4.4 |
| 372.8 | 2.144 | 54.2 ± 4.1 |
| 372.8 | 2.958 | 63.3 ± 3.5 |
| 372.8 | 3.576 | 70.8 ± 3.2 |
| 372.8 | 4.120 | 75.4 ± 2.8 |
| 372.8 | 5.007 | 83.9 ± 1.7 |
| 298.1 | 0.314 | 44.3 ± 0.9 |
| 298.1 | 0.540 | 64.2 ± 0.7 |
| 298.1 | 0.666 | 72.4 ± 0.5 |
| 298.1 | 0.772 | 78.0 ± 0.4 |
| 298.1 | 0.831 | 81.5 ± 0.3 |
| 298.1 | 0.930 | 87.4 ± 0.1 |

### Example 8

Experimental solubility (TPx) data for ammonia in N,N-dimethylethanolammonium ethanoate [(CH₃)₂NHCH₂CH₂OH][CH₃COO] are summarized in Table 8.

TABLE 8
NH₃ (1) + [(CH₃)₂NHCH₂CH₂OH][CH₃COO] (2)

| T/K | P/MPa | 100x₁/mol % |
|---|---|---|
| 283.2 | 0.136 | 47.7 ± 3.7 |
| 283.2 | 0.198 | 62.0 ± 2.4 |
| 283.2 | 0.288 | 71.6 ± 1.8 |
| 283.2 | 0.316 | 76.8 ± 1.2 |
| 283.2 | 0.415 | 81.9 ± 0.8 |
| 283.2 | 0.491 | 86.5 ± 0.5 |
| 298.1 | 0.163 | 47.5 ± 3.8 |
| 298.1 | 0.278 | 61.6 ± 2.4 |
| 298.1 | 0.431 | 71.3 ± 1.8 |
| 298.1 | 0.500 | 76.5 ± 1.2 |
| 298.1 | 0.641 | 81.6 ± 0.8 |
| 298.1 | 0.769 | 86.4 ± 0.5 |
| 322.7 | 0.277 | 46.6 ± 4.2 |
| 322.7 | 0.463 | 60.9 ± 2.3 |
| 322.7 | 0.786 | 70.4 ± 1.7 |
| 322.7 | 0.980 | 75.7 ± 1.1 |
| 322.7 | 1.250 | 80.9 ± 0.7 |
| 322.7 | 1.521 | 86.0 ± 0.5 |
| 348.0 | 0.433 | 45.4 ± 4.7 |
| 348.0 | 0.693 | 60.0 ± 3.1 |
| 348.0 | 1.335 | 69.1 ± 2.0 |
| 348.0 | 1.680 | 74.5 ± 1.3 |
| 348.0 | 2.164 | 79.9 ± 1.0 |
| 348.0 | 2.689 | 85.3 ± 0.6 |
| 372.8 | 1.994 | 67.5 ± 2.2 |
| 372.8 | 2.529 | 73.1 ± 1.3 |
| 372.8 | 3.305 | 78.5 ± 0.7 |
| 372.8 | 4.249 | 84.4 ± 0.5 |
| 298.1 | 0.401 | 71.4 ± 2.0 |
| 298.1 | 0.496 | 76.5 ± 1.2 |
| 298.1 | 0.637 | 81.6 ± 0.8 |
| 298.1 | 0.791 | 86.4 ± 0.5 |

### Example 9

Absorption cycle calculations were developed for compositions of invention using the computer code developed by Yokozeki in “Theoretical performances of various refrigerant-absorbent pairs in a vapor-absorption refrigeration cycle by the use of equations of state”, 2005, Applied Energy, 80, 383-399. The detailed assumptions made in the cycle calculation are described in that reference, and in US 2006/0197053 A1, Shiflett, et al, specifically paragraphs 0063 through 0094. Proper binary interaction parameters for the equation of state have been determined using the present PTx data. Results of the present invention for the cycle performance are compared in Table 9, together with the well-known ammonia-water system. The energy efficient performance, also called coefficient of performance (COP), is explained in detail in the above references. The ammonia-RTIL COPs are somewhat lower than that of the ammonia-water system. However, in this calculation, the extra energy cost required for a rectifier unit required to condense water, which has a significant vapor pressure, was not considered in the ammonia-water case. Because the ionic liquids have no measurable vapor pressure, a rectifier is not required in the cycle. In actual applications, ammonia+ionic liquid pairs may compete with the cycle performance of the traditional absorption cycle using ammonia and water. An additional benefit is the reduced cost of cycle equipment because no rectifier for the absorbent is required.

TABLE 9
Comparisons of Thermodynamic Absorption Cycle*⁾.

| | | x_{gen} | x_{abs} | |
|---|---|---|---|---|
| | | (mass | (mass | |
| Example No. - System (1)/(2) | f | %) | %) | COP |
| 1 - NH₃/[bmim][PF₆] | 17.27 | 94.5 | 89.0 | 0.575 |
| 2 - NH₃/[hmim][Cl] | 14.26 | 93.9 | 87.3 | 0.525 |
| 3 - NH₃/[emim][Tf₂N] | 24.57 | 96.3 | 92.4 | 0.589 |
| 4 - NH₃/[bmim][BF₄] | 12.98 | 95.7 | 88.3 | 0.557 |
| 5 - NH₃/[emim][CH3COO] | 12.55 | 92.3 | 85.0 | 0.573 |
| 6 - NH₃/[emim][EtOSO3] | 17.55 | 95.2 | 89.8 | 0.485 |
| 7 - NH₃/[emim][SCN] | 12.42 | 92.7 | 85.3 | 0.557 |
| 8 - NH₃/[(CH₃)₂NHCH₂CH₂OH][CH3COO] | 7.60 | 84.1 | 73.1 | 0.612 |
| Comparative Control - NH₃/Water | 2.54 | 59.5 | 36.1 | 0.646 |

*⁾Cycle condition: T(generator)/T(condenser)/T(absorber)/T(evaporator) = 100/40/30/10° C.;
f: mass-flow-rate ratio (=solution/refrigerant);
x_{gen}: absorbant mass % (ionic liquid mass %) at the generator exit;
x_{abs}: absorbant mass % (ionic liquid mass %) at the absorber exit.

### Example 10

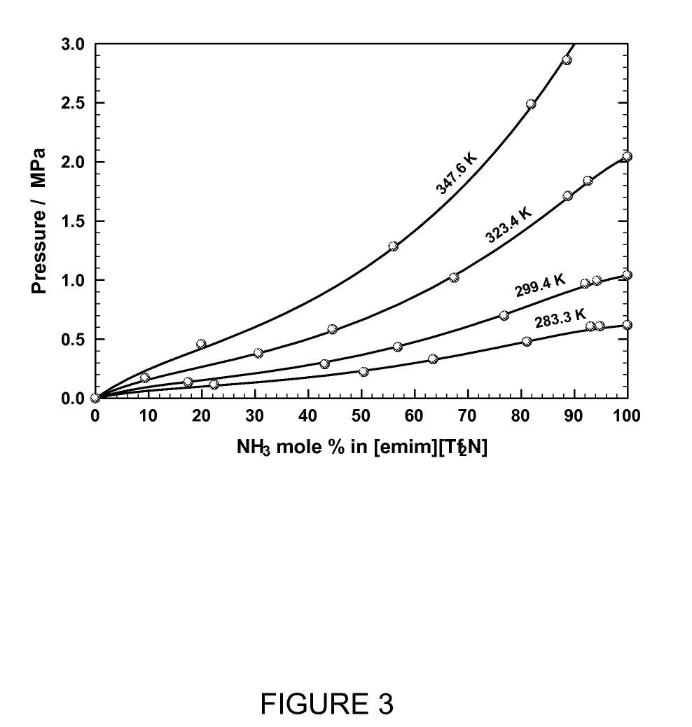

This example illustrates that ionic liquids can absorb large amounts of ammonia reversibly as a function of pressure. FIG. 3 is a plot of the mole percent of ammonia absorbed into the ionic liquid [emim][Tf₂N]. At 298 K, the ionic liquid absorbs almost 10 mole percent at 80 kPa (0.08 MPa). This converts into a storage capacity of about 0.3 millimol per gram of ionic liquid, which is much less than the 25 to 40 millimol per gram of solid mentioned previously. However, if the temperature is lowered to 283 K the storage capacity increases to almost 20 mole percent at 80 kPa (0.08 bar) which is 0.6 millimol per gram of ionic liquid. Most importantly if the pressure is increased, then large amounts of ammonia can be stored in the ionic liquid. For example, at pressures of about 1 MPa over 90 mole percent ammonia can be stored in the ionic liquid which is about 25 millimol of ammonia per gram of ionic liquid. This compares well with the best solid adsorbents and most importantly the absorption/desorption process is completely reversible with no loss of capacity in the ionic liquid to store additional ammonia. Also, other ionic liquids with a lower molecular weight such as [emim][acetate] can reach even greater concentrations closer to 50 millimol of ammonia per gram of ionic liquid. Also, if the temperature is lowered to 283 K, pressures closer to 0.5 MPa (or 5 atm) can achieve the same ammonia storage capacities of 25 to 50 millimol ammonia per gram of ionic liquid. Finally, this example is merely illustrative. Other combinations of temperature and pressure (i.e. temperatures lower than 283 K) maybe possible to reach 25 to 50 millimol ammonia per gram of ionic liquid at even lower pressures such as 80 kPa.

What is claimed is:

1. A composition comprising ammonia and at least one ionic liquid wherein the composition comprises about 1 to about 99 mole % of ammonia over a temperature range from about −40 to about 130° C. at a pressure from about 1 to about 110 bar.

2. The composition of claim 1 wherein said at least one ionic liquid has a cation selected from the group consisting of: 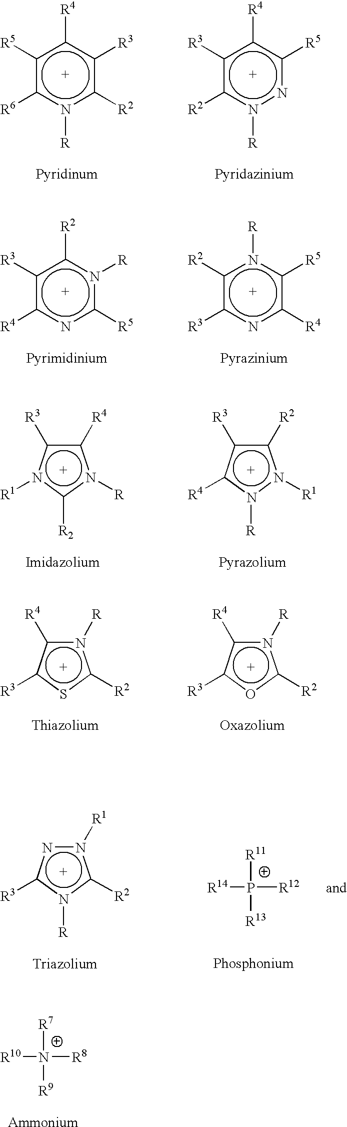
wherein R, R¹, R⁷, R⁸, R⁹, and R¹⁰ are independently selected from the group consisting of:
(i) hydrogen
(ii) —CH₃, —C₂H₅, or C₃ to C₂₅ straight-chain, branched or cyclic alkane or alkene, optionally substituted with at least one member selected from the group consisting of Cl, Br, F, I, OH, NH₂ and SH;
(iii) —CH₃, —C₂H₅, or C₃ to C₂₅ straight-chain, branched or cyclic alkane or alkene comprising one to three heteroatoms selected from the group consisting of O, N and S, and optionally substituted with at least one member selected from the group consisting of Cl, Br, F, I, OH, NH₂ and SH;
(iv) C₆ to C₂₀ unsubstituted aryl, or C₃ to C₂₅ unsubstituted heteroaryl having one to three heteroatoms independently selected from the group consisting of O, N and S; and
(v) C₆ to C₂₅ substituted aryl, or C₃ to C₂₅ substituted heteroaryl having one to three heteroatoms independently selected from the group consisting of O, N and S; and wherein said substituted aryl or substituted heteroaryl has one to three substituents independently selected from the group consisting of:
(1) —CH₃, —C₂H₅, or C₃ to C₂₅ straight-chain, branched or cyclic alkane or alkene, optionally substituted with at least one member selected from the group consisting of Cl, Br, F I, OH, NH₂ and SH,
(2) OH,
(3) NH₂, and
(4) SH;
R², R³, R⁴, R⁵, and R⁶ are independently selected from R and a halogen;
R¹¹, R¹², R¹³, and R¹⁴ are independently selected from R with the proviso that R¹¹, R¹², R¹³, and R¹⁴ are not hydrogen; and
wherein, optionally, at least two of R, R¹, R², R³, R⁴, R⁵, R⁶, R⁷, R⁸, R⁹, R¹⁰, R¹¹, R¹², R¹³, and R¹⁴ can together form a cyclic or bicyclic alkanyl or alkenyl group;
and,
an anion selected from the group consisting of [CH₃CO₂]⁻, [HSO₄]⁻, [CH₃OSO₃]⁻, [C₂H₅OSO₃]⁻, [AlCl₄]⁻, [CO₃]²⁻, [HCO₃]⁻, [NO₂]⁻, [NO₃]⁻, [SO₄]⁻, [PO₄]³⁻, [HPO₄]²⁻, [H₂PO₄]⁻, [HSO₃]⁻, [CuCl₂]⁻, Cl⁻, Br⁻, I⁻, SCN⁻, and a fluorinated anion.

3. The composition of claim 2 wherein at least one of R, R¹, R², R³, R⁴, R⁵, R⁶, R⁷, R⁸, R⁹, R¹⁰, R¹¹, R¹², R¹³, and R¹⁴ comprises one or more fluorine(s).

4. The composition of claim 2 wherein said at least one ionic liquid comprises a fluorinated anion and the fluorinated anion is selected from the group consisting of [BF₄]⁻, [BF₃CF₃]⁻, [BF₃C₂F₅]⁻, [PF₆]⁻, [PF₃(C₂F₅)₃]⁻, [SbF₆]⁻, [CF₃SO₃]⁻, [HCF₂CF₂SO₃]⁻, [CF₃HFCCF₂SO₃]⁻, [HCClFCF₂SO₃]⁻, [(CF₃SO₂)₂N]⁻, [(CF₃CF₂SO₂)₂N]⁻, [(CF₃SO₂)₃C]⁻, [CF₃CO₂]⁻, [CF₃OCFHCF₂SO₃]⁻, [CF₃CF₂OCFHCF₂SO₃]⁻, [CF₃CFHOCF₂CF₂SO₃]⁻, [CF₂HCF₂OCF₂CF₂SO₃]⁻, [CF₂₁CF₂OCF₂CF₂SO₃]⁻, [CF₃CF₂OCF₂CF₂SO₃]⁻, [(CF₂HCF₂SO₂)₂N]⁻, [(CF₃CFHCF₂SO₂)₂N]⁻, and F⁻.

5. The composition of claim 2 wherein the cation comprises imidazolium and the anion is selected from the group consisting of [BF₄]⁻, [BF₃CF₃]⁻, [BF₃C₂F₅]⁻, [PF₆]⁻, [PF₃(C₂F₅)₃]⁻, [SbF₆]⁻, [CF₃SO₃]⁻, [HCF₂CF₂SO₃]⁻, [CF₃HFCCF₂SO₃]⁻, [HCClFCF₂SO₃]⁻, [(CF₃SO₂)₂N]⁻, [(CF₃CF₂SO₂)₂N]⁻, [(CF₃SO₂)₃C]⁻, [CF₃CO₂]⁻, [CF₃OCFHCF₂SO₃]⁻, [CF₃CF₂OCFHCF₂SO₃]⁻, [CF₃CFHOCF₂CF₂SO₃]⁻, [CF₂HCF₂OCF₂CF₂SO₃]⁻, [CF₂ICF₂OCF₂CF₂SO₃]⁻, [CF₃CF₂OCF₂CF₂SO₃]⁻, [(CF₂HCF₂SO₂)₂N]⁻, [(CF₃CFHCF₂SO₂)₂N]⁻, and [CH₃OSO₃]⁻.

6. The composition of claim 5 wherein cation is 1-butyl-3-methylimidazolium.

7. The composition of claim 5 wherein cation is 1-ethyl-3-methylimidazolium.

8. The composition of claim 7 wherein the anion is selected from the group consisting of [(CF₃CF₂SO₂)₂N]⁻, [PF₆]⁻, and [HCF₂CF₂SO₃]⁻.

9. The composition of claim 5 wherein the cation comprises 1,3-dimethylimidazolium.

10. The composition of claim 2 wherein the anion is [CH₃CO₂]⁻.

11. The composition of claim 10 wherein the cation is N,N-dimethylammonium ethanol.

12. The composition of claim 1 wherein the composition comprises about 5 to 95 mol % of ammonia.

13. The composition of claim 1 wherein the ionic liquid has a viscosity at 25° C. of less than 100 cp.

14. An absorption cycle comprising a composition comprising ammonia and at least one ionic liquid wherein the composition comprises about 1 to about 99 mole % of ammonia over a temperature range from about −40 to about 130° C. at a pressure from about 1 to about 110 bar.

15. An absorption cycle of claim 14 wherein said at least one ionic liquid has a cation selected from the group consisting of: 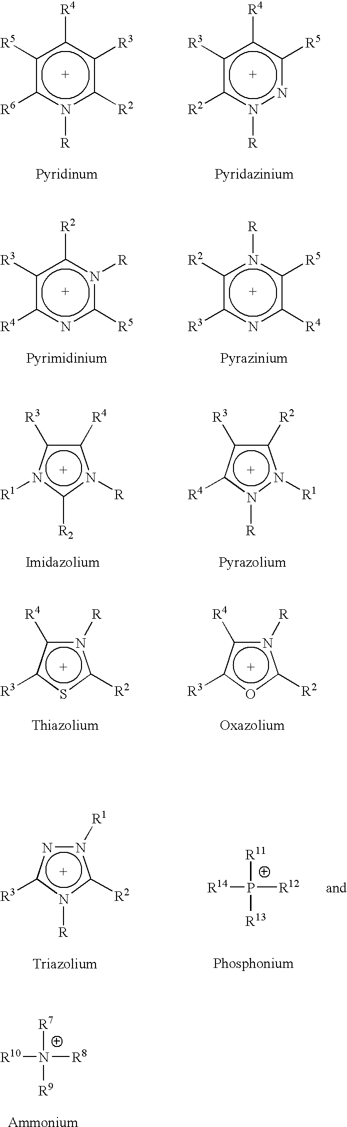
wherein R, R¹, R⁷, R⁸, R⁹, and R¹⁰ are independently selected from the group consisting of:
(i) Hydrogen
(ii) —CH₃, —C₂H₅, or C₃ to C₂₅ straight-chain, branched or cyclic alkane or alkene, optionally substituted with at least one member selected from the group consisting of Cl, Br, F, I, OH, NH₂ and SH;
(iii) —CH₃, —C₂H₅, or C₃ to C₂₅ straight-chain, branched or cyclic alkane or alkene comprising one to three heteroatoms selected from the group consisting of O, N and S, and optionally substituted with at least one member selected from the group consisting of Cl, Br, F, I, OH, NH₂ and SH;
(iv) C₆ to C₂₀ unsubstituted aryl, or C₃ to C₂₅ unsubstituted heteroaryl having one to three heteroatoms independently selected from the group consisting of O, N and S; and
(v) C₆ to C₂₅ substituted aryl, or C₃ to C₂₅ substituted heteroaryl having one to three heteroatoms independently selected from the group consisting of O, N and S; and wherein said substituted aryl or substituted heteroaryl has one to three substituents independently selected from the group consisting of:
(1) —CH₃, —C₂H₅, or C₃ to C₂₅ straight-chain, branched or cyclic alkane or alkene, optionally substituted with at least one member selected from the group consisting of Cl, Br, F I, OH, NH₂ and SH,
(2) OH,
(3) NH₂, and
(4) SH;
R², R³, R⁴, R⁵, and R⁶ are independently selected from R and a halogen;
R¹¹, R¹², R¹³, and R¹⁴ are independently selected from R with the proviso that R¹¹, R¹², R¹³, and R¹⁴ are not hydrogen; and
wherein, optionally, at least two of R, R¹, R², R³, R⁴, R⁵, R⁶, R⁷, R⁸, R⁹, R¹⁰, R¹¹, R¹², R¹³, and R¹⁴ can together form a cyclic or bicyclic alkanyl or alkenyl group;
and,
an anion selected from the group consisting of [CH₃CO₂]⁻, [HSO₄]⁻, [CH₃OSO₃]⁻, [C₂H₅OSO₃]⁻, [AlCl₄]⁻, [CO₃]²⁻, [HCO₃]⁻, [NO₂]⁻, [NO₃]⁻, [SO₄]²⁻, [PO₄]³⁻, [HPO₄]²⁻, [H₂PO₄]⁻, [HSO₃]⁻, [CuCl₂]⁻, Cl⁻, Br⁻, I⁻, SCN⁻, and a fluorinated anion.

16. The absorption cycle of claim 15 comprising an absorber side having an exit, and a generator side having an exit, wherein the absorber side has a concentration of ionic liquid at the exit of greater than about 70% by weight of said composition; and the generator side has a concentration of ionic liquid at the exit of greater than about 80% by weight of said composition.

17. The absorption cycle of claim 16 wherein the absorber side has a concentration of ionic liquid at the exit of greater than about 80% by weight of said composition; and the generator side has a concentration of ionic liquid at the exit of greater than about 90% by weight of said composition.

18. The absorption cycle of claim 17 wherein the ionic liquid comprises an imidazolium cation.

19. The absorption cycle of claim 16 wherein the ionic liquid comprises a N,N-dimethylammonium ethanol cation.

20. A process for storing ammonia comprising absorbing ammonia in an ionic liquid to provide a composition comprising about 1 to about 99 mole % of ammonia over a temperature range from about −40 to about 130° C. at a pressure from about 1 to about 110 bar.

21. The process of claim 20 wherein the composition comprises about 10 to 95 mole % ammonia.

22. The process of claim 20 wherein the ionic liquid has a cation selected from the group consisting of: 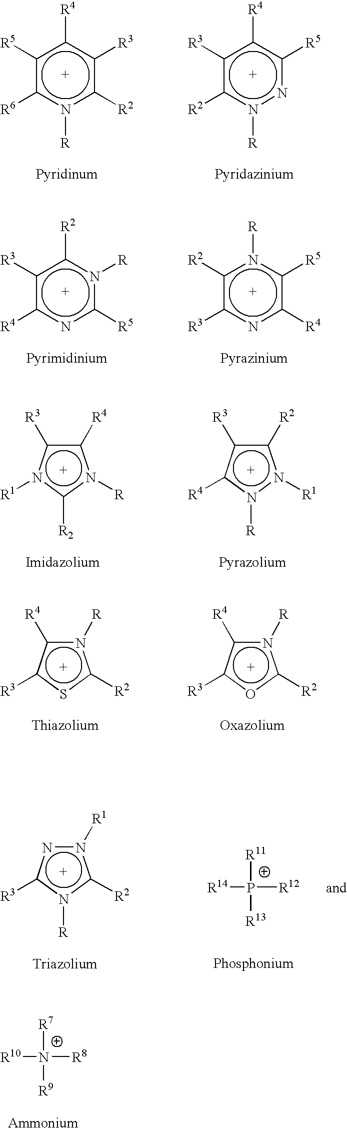
wherein R, R¹, R⁷, R⁸, R⁹, and R¹⁰ are independently selected from the group consisting of:
(i) hydrogen
(ii) —CH₃, —C₂H₅, or C₃ to C₂₅ straight-chain, branched or cyclic alkane or alkene, optionally substituted with at least one member selected from the group consisting of Cl, Br, F, I, OH, NH₂ and SH;
(iii) —CH₃, —C₂H₅, or C₃ to C₂₅ straight-chain, branched or cyclic alkane or alkene comprising one to three heteroatoms selected from the group consisting of O, N and S, and optionally substituted with at least one member selected from the group consisting of Cl, Br, F, I, OH, NH₂ and SH;
(iv) C₆ to C₂₀ unsubstituted aryl, or C₃ to C₂₅ unsubstituted heteroaryl having one to three heteroatoms independently selected from the group consisting of O, N and S; and
(v) C₆ to C₂₅ substituted aryl, or C₃ to C₂₅ substituted heteroaryl having one to three heteroatoms independently selected from the group consisting of O, N and S; and wherein said substituted aryl or substituted heteroaryl has one to three substituents independently selected from the group consisting of:
(4) —CH₃, —C₂H₅, or C₃ to C₂₅ straight-chain, branched or cyclic alkane or alkene, optionally substituted with at least one member selected from the group consisting of Cl, Br, F I, OH, NH₂ and SH,
(5) OH,
(6) NH₂, and
(4) SH;
R², R³, R⁴, R⁵, and R⁶ are independently selected from R and a halogen;
R¹¹, R¹², R¹³, and R¹⁴ are independently selected from R with the proviso that R¹¹, R¹², R¹³, and R¹⁴ are not hydrogen; and
wherein optionally at least two of R, R¹, R², R³, R⁴, R⁵, R⁶, R⁷, R⁸, R⁹, R¹⁰, R¹¹, R¹², R¹³, and R¹⁴ can together form a cyclic or bicyclic alkanyl or alkenyl group; and,
an anion selected from the group consisting of [CH₃CO₂]⁻, [HSO₄]⁻, [CH₃OSO₃]⁻, [C₂H₅OSO₃]⁻, [AlCl₄]⁻, [CO₃]²⁻, [HCO₃]⁻, [NO₂]⁻, [NO₃]⁻, [SO₄]²⁻, [PO₄]³⁻, [HPO₄]²⁻, [H₂PO₄]⁻, [HSO₃]⁻, [CuCl₂]⁻, Cl⁻, Br⁻, I⁻, SCN⁻, and a fluorinated anion.
